(19) United States
(12) Patent Application Publication
(10) Pub. No.: US 2016/0129449 A1
(43) Pub. Date: May 12, 2016

(54) WEAR APPARATUS FOR GRINDING ROLLS AND METHODS THEREOF

(71) Applicant: FLSMIDTH A/S, Valby (DK)

(72) Inventors: Edward James Pownell, Midvale, UT (US); Nicholas Roman, Schnecksville, PA (US); David Dustin Udy, Layton, UT (US)

(21) Appl. No.: 14/898,183

(22) PCT Filed: Sep. 27, 2013
(86) PCT No.: PCT/US2013/062072

§ 371 Date: Dec. 14, 2015

Related U.S. Application Data
(60) Provisional application No. 61/840,685, filed on Jun. 28, 2013.

(51) Int. Cl. B02C 4/28; B02C 4/02

(52) U.S. Cl. CPC B02C 4/283; B02C 4/02

(57) ABSTRACT

A roller press is disclosed. The roller press [1] may comprise a pair of side-by-side rollers [22] configured to form a nip therebetween. The roller press [1] may further be configured to grind or crush feed material. Each of the side-by-side rollers [22] may share a first end and a second end. A pair of cheek plate assemblies [100, 200, 300, 400] may be provided to the roller press [1], wherein one cheek plate assembly [100, 200, 300, 400] is provided adjacent said first end of the rollers [22] and another cheek plate assembly [100, 200, 300, 400] is provided adjacent said second end of the rollers [22]. Each cheek plate assembly [100, 200, 300, 400] may be configured for engagement with a frame [30] and/or housing [40] portion of the roller press [1]. Cheek plate assemblies [100, 200, 300, 400] may further comprise at least one wear bar [110, 210, 310, 410], wherein the at least one wear bar [110, 210, 310, 410] is configured with a wear surface [118, 218, 318, 418] which is located proximate to a wear zone 180. As the wear bar [110, 210, 310, 410] wears, it may be adjusted via indexing means [126, 226, 326] and held in place via holding means [125, 225, 325, 425].

### CROSS-REFERENCE OF RELATED APPLICATIONS

This application is an international application which claims the benefit of U.S. Provisional Patent Application No. 61/840,685 filed on 28 Jun. 2013.

### BACKGROUND OF THE INVENTION

This invention relates to crushing, grinding, and comminution equipment, and more particularly to high pressure grinding roller (HPGR) systems used, for instance, in the mining, cement, coal, aggregate, grain, and minerals processing industries.

Conventional grinding rollers may experience high amounts of material loss in areas of the nip near axial end portions of rollers and/or adjacent roller edges. The material loss causes highly abrasive flows and movements of both autogenous layer and feed material which can prematurely wear certain isolated zones on cheek plates. Cheek plates are typically positioned perpendicular to the nip at end portions of the rollers, and generally serve to keep feed material from short-circuiting/escaping the roller nip via the roller ends. In actual field use, a small diamond-shaped hole can form by material blasting against the cheek plate where the majority of material flow at the end of the nip is the greatest and/or most concentrated. Even the most heavily-armored tungsten-plated cheek plates can eventually be compromised in these certain isolated zones and can be completely penetrated by continuous edge flow. Cheek plate wear rates may be considerable in some instances, requiring as many as 2 to 3 cheek plate refurbishments/repairs/replacements/change-outs for every single roller refurbishment/repair/replacement. This adds significant downtime to grinding operations, increases maintenance costs, and negatively impacts operating expenditures and bottom-line profit margins.

### OBJECTS OF THE INVENTION

It is, therefore, an object of the invention to provide a mechanically-robust cheek plate apparatus which is capable of withstanding massive amounts of edge flow wear in certain isolated wear zones where extreme erosion is problematic.

It is also an object of the invention to provide components to cheek plates which are configured to adequately support, strengthen, stabilize, and resist wear in specific areas.

It is yet another object of the invention to provide means for quickly repairing damaged or highly worn portions of a cheek plate without necessarily needing to remove the cheek plate from the roller press or other component thereof.

Another object of the invention is to provide means for quickly repairing damaged or highly worn portions of a cheek plate without necessarily needing to perform difficult repair tasks such as close-quarters in-situ welding.

It is another object of the invention to provide a wear system for a cheek plate (in a grinding roller) which can be assembled, disassembled, and refurbished much simpler and easier than can be done using existing apparatus and methods.

It is a further object of the invention to provide means for dressing inner surfaces of a cheek plate with inexpensive, autogenous wear protection.

These and other objects of the invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

A roller press is disclosed. The roller press may comprise a pair of side-by-side rollers which are configured to form a nip therebetween and configured to grind or crush feed material. Each of the side-by-side rollers may share a first end and a second end. A pair of cheek plate assemblies may further be provided to the roller press. One of the pair of cheek plate assemblies may be provided adjacent said first end of the rollers and the other of the pair of cheek plate assemblies may be provided adjacent said second end of the rollers. Each cheek plate assembly may be configured for engagement with a frame and/or a housing portion of the roller press; and each cheek plate assembly may further comprise at least one wear bar. The at least one wear bar may be configured with a wear surface which is located proximate to a wear zone. The at least one wear bar may be configured to greatly increase wear life in said wear zone. In some embodiments, the roller press may further comprise a surface wear component selected from a wear surface, a front plate, an angled lead-in plate, a first roller wear plate, a second roller wear plate, a rock box, a first shroud, a second shroud, a first wear plate, a central wear plate, a lower wear plate, an armored section, or a combination thereof. In some embodiments, cheek plate assemblies may comprise more than one wear bar at a wear zone. In some instances, wear bars may be adjustable so as to accommodate wear of said at least one wear bar over time. In some embodiments, indexing means which is configured to provide a finite or infinite number of adjustments to said at least one wear bar may be provided. The indexing means may further comprise holding means for holding said indexing means in place, thereby preventing movement of the at least one wear bar relative to the roller press. In preferred embodiments, wear bars comprise a hard material such as a ceramic or carbide-based material or alloy which is resistant to the high amounts of wear found in crushing/grinding operations.

A cheek plate apparatus is also disclosed. The cheek plate assembly may be configured for engagement with a frame and/or a housing portion of the roller press and may comprise at least one wear bar. The at least one wear bar may be configured with a wear surface which is located proximate to a wear zone. The at least one wear bar may be configured to greatly increase wear life in said wear zone. In some embodiments, the cheek plate apparatus may further comprise a surface wear component selected from a wear surface, a front plate, an angled lead-in plate, a first roller wear plate, a second roller wear plate, a rock box, a first shroud, a second shroud, a first wear plate, a central wear plate, a lower wear plate, an armored section, or a combination thereof. In some embodiments, the cheek plate apparatus may comprise more than one wear bar at a wear zone. In some instances, wear bars may be adjustable so as to accommodate wear of the wear bars over time. In some embodiments, indexing means which is configured to provide a finite or infinite number of adjustments to wear bars may be provided. The indexing means may further comprise holding means for holding said indexing means in place, thereby preventing movement of wear bars relative to the roller press. In preferred embodiments, wear bars may comprise a hard material such as a ceramic or carbide-based material or alloy and are resistant to the high amounts of wear found in crushing/grinding operations.

A method of crushing/grinding using a wear bar is also disclosed. The method comprises the steps of providing a roller press having a cheek plate assembly configured for engagement with a frame and/or a housing portion of said roller press; crushing/grinding feed material until the wear surface of at least one wear bar is worn; adjusting, using indexing means, a position of the at least one wear bar relative to the roller press such that the worn wear surface of the wear bar moves closer to a roller within the roller press; and, holding a position of the at least one wear bar relative to said roller within the roller press using holding means. In some embodiments, the at least one wear bar may be configured with a wear surface which is located proximate to a wear zone susceptible to extreme erosion. The at least one wear bar may be of sufficient dimensions to greatly increase wear life of the cheek plate in said wear zone.

### BRIEF DESCRIPTION OF THE DRAWINGS

To complement the description which is being made, and for the purpose of aiding to better understand the features of the invention, a set of drawings illustrating preferred cheek plate assembly and methods of making the same is attached to the present specification as an integral part thereof, in which the following has been depicted with an illustrative and non-limiting character. It should be understood that like reference numbers used in the drawings may identify like components.

FIG. 1 is an inner isometric view of a cheek plate assembly and arrangement of surface wear components according to some embodiments;

FIG. 2 is an outer isometric view of the cheek plate assembly shown in FIG. 1;

FIG. 3 is a top plan view of the cheek plate assembly shown in FIGS. 1 and 2;

FIG. 4 is an inner isometric view of a cheek plate assembly and arrangement of surface wear components according to some embodiments;

FIG. 5 is an inner isometric view of a cheek plate assembly and arrangement of surface wear components according to some embodiments;

FIG. 6 is an outer isometric view of the cheek plate assembly shown in FIG. 5;

FIG. 7 is a detailed partial cross-sectional view of the wear assembly of the cheek plate assembly shown in FIGS. 5 and 6, more clearly showing a surface wear component according to some embodiments of the invention.

FIG. 8 shows a perspective view of a roller press employing cheek plate assemblies according to the embodiment shown in FIG. 1;

FIG. 9 is a sagittal cross-sectional view showing one-half of the roller press shown in FIG. 8, and more clearly showing a functionality of a cheek plate apparatus according to certain aspects of the invention;

FIG. 10 is a transverse cross-sectional view of the roller press shown in FIG. 8 further showing a surface wear component's functionality according to some embodiments; and,

FIGS. 11 and 12 show inner and outer isometric views, respectively, of a cheek plate assembly having surface wear components according to some embodiments.

In the following, the invention will be described in more detail with reference to drawings in conjunction with exemplary embodiments.

### DETAILED DESCRIPTION OF THE INVENTION

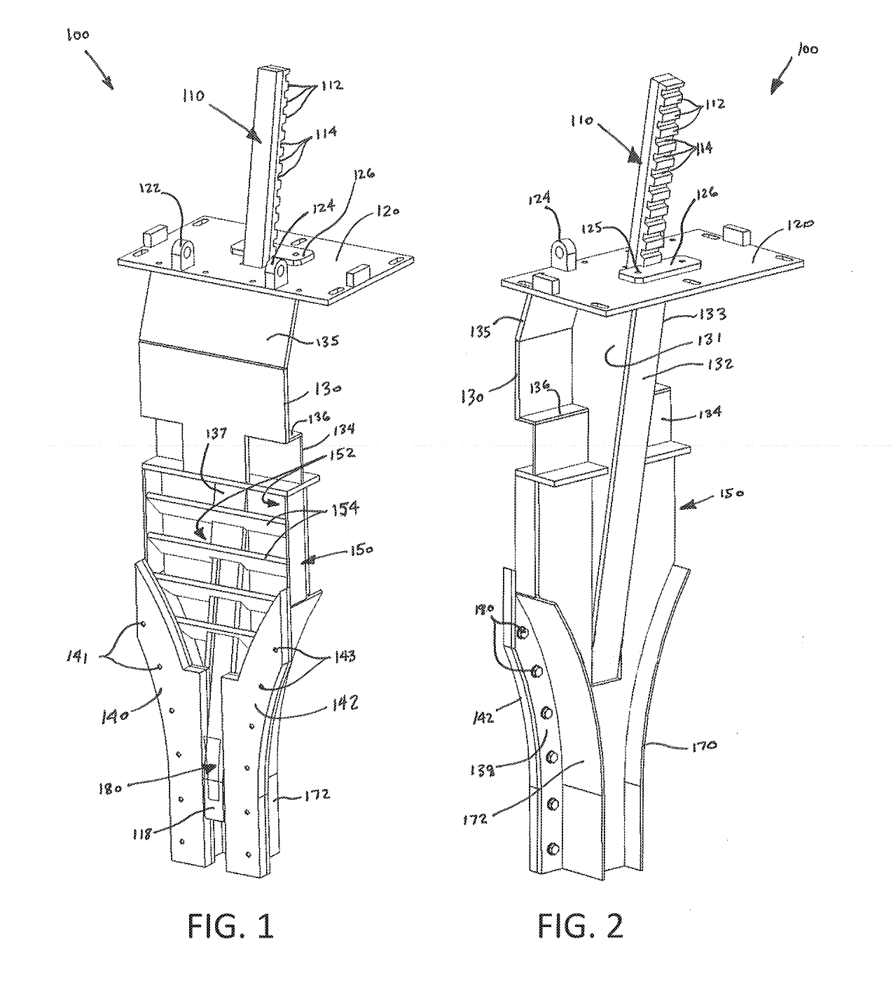

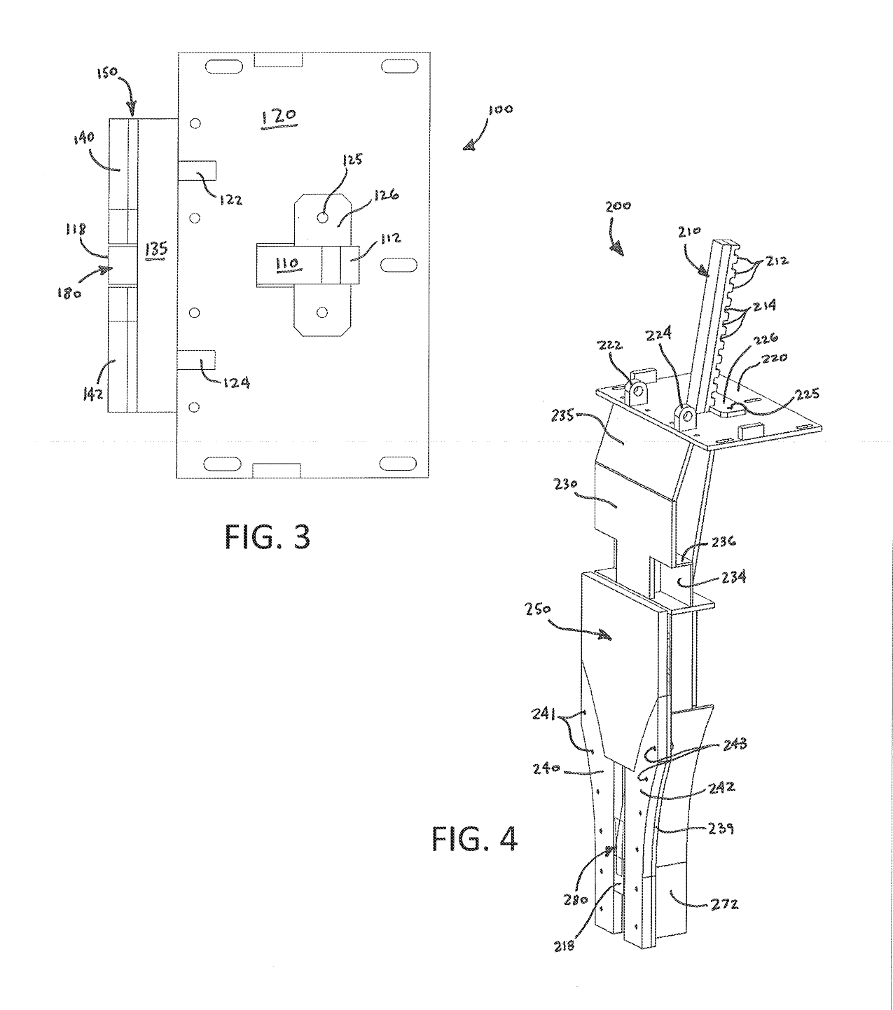

FIGS. 1-3 depict an exemplary embodiment of a cheek plate apparatus 100 having a unique arrangement of surface wear components. The cheek plate apparatus 100 may comprise an elongated wear bar 110 having a plurality of teeth 112 and roots 114. The wear bar 110 may be configured in different lengths, materials, cross-sectional sizes, and cross-sectional shapes. In preferred embodiments, a lower distal end of the wear bar 110 comprises a wear surface 118 which is configured to be initially generally parallel and/or planar with ends of rollers 20, and configured to maintain said generally parallel and/or planar relationship with ends of rollers 20 during use. The cheek plate apparatus 100 may further comprise a top portion 120 having a first hoist 122 and/or a second hoist 124 for lifting, moving, installing, uninstalling, and transporting the cheek plate apparatus 100. The cheek plate apparatus 100 may further comprise indexing means 126 which is held in place with respect to the top portion 120 by holding means 125. In the particular embodiment shown, indexing means 126 comprises a panel that may be slid towards and into a root of the wear bar 110 in order to set a position of the wear surface 118 relative to the rollers 20 and nip. However, while not shown, the indexing means 126 could alternatively comprise, without limitation, a spur or a worm gear which meshes with teeth 112, a hydraulic ram attached to an end of the wear bar 110, a mechanical linkage (between the wear bar 110 and the top portion 120, frame 30, or housing 40), a wedge, insert, or rod which slides transversely between teeth 112, or other equivalent mechanisms for discretely adjusting the position of a wear bar 110 within the cheek plate apparatus 100. As it is shown in the drawings, the indexing means 126 may be slid away from the wear bar 110 to let the wear bar 110 slide downwardly—thereby allowing the wear surface 118 to move closer towards the ends of rollers 20 and replace an amount of worn material. Holding means 125 may be provided to maintain the indexing means 126 in a proper orientation/position. Holding means 125 may comprise, for example, a screw, a bolt, a pin, or other fastener in combination with an aperture through the panel of indexing means 126, and an aperture through top portion 120. When the indexing means 126 is set to effectively position the wear surface 118 of the wear bar 110 in the appropriate location within a wear zone 180, holding means 125 may be engaged.

Alternatively, while not shown, indexing 126 and holding 125 means may comprise a cross-pin (e.g., a cotter) through one of a series of intermittent holes extending transversely through the wear bar 110 along its length, wherein a portion of the cross-pin is configured to rest on top portion 120 while it is inserted through said one of a series of intermittent holes, and the cross-pin can be removed and re-inserted into another one of the series of intermittent holes extending transversely through the wear bar 110.

The cheek plate apparatus 100 may further comprise a first side 131, an angled back side 132, a second side 133, and an angled front side 137 which receives, holds, and/or maintains the wear bar in its proper spatial orientation relative to the cheek plate apparatus 100. For example, in the figure shown, first side 131, angled back side 132, second side 133, and angled front side 137 are configured to keep wear bar 110 oriented at an angle with respect to the cheek plate apparatus 100 (e.g., at an angle with respect to top portion 120). This angle generally provides a larger wear surface 118 and also provides a mechanical reduction to afford finer spacing adjustments between the wear surface 118 and rollers 20. It is contemplated that a completely vertical wear bar 110 may be utilized in a similar fashion without departing from the scope of the invention. The cheek plate apparatus 100 may further comprise a front plate 130, a back plate 134, an angled lead-in plate 135, a transverse plate 136, and one or more flanges 139 configured to support and/or hold a first roller wear plate 140 via a first connection 141. The one or more flanges 139 may further be configured to support a second roller wear plate 142 via a second connection 143. Connecting means 190 such as a number of bolts, through holes in the one or more flanges 139, and threaded apertures within wear plates 140, 142 may be provided to secure the wear plates 140, 142 to the cheek plate apparatus 100. Equivalent means of connecting wear plates 140, 142 to flanges 139 are also envisaged.

A rock box 150 may be provided on an inner surface of the cheek plate assembly to serve as an autogenous surface wear component. The rock box 150 may comprise a compartment comprised of one or more angular pockets 152. Angular pockets 152 may be formed by placing one or more removable slats 154 within the rock box 150. Angled slots (not clearly shown) may be provided within inner portions of the rock box 150 for removable slats 154 to rest, or a number of flanges or connectors (not shown) may be utilized. In use, feed rock collects within the angular pockets 152 and effectively forms an autogenous layer on the cheek plate apparatus 100. As feed rock enters a roller, it will generally hit and abrade material disposed within angular pockets 152 and overhanging the removable slats 154 first, and will therefore, not likely rub or wear down portions of the cheek plate assembly 100 or removable slats 154. When the removable slats 154 wear down, they may be removed and replaced with new or refurbished slats 154. While it is less preferred, slats 154 may be permanently welded or otherwise affixed to the rock box 150. The cheek plate apparatus 100 may further comprise a first 170 and/or a second 172 shroud to prevent dust and ground material from working its way into the bearings of a roller press 1 and/or other components of a roller press 1.

FIG. 4 shows an inner isometric view of a cheek plate assembly and arrangement of surface wear components according to another embodiment. The cheek plate apparatus 200 may, similarly to the embodiment of FIG. 1, comprise a wear bar 210 having a plurality of teeth 212 and a plurality of roots 214. The wear bar 210 may be configured in different lengths, materials, cross-sectional sizes, and cross-sectional shapes. In preferred embodiments, a lower distal end of the wear bar 210 comprises a wear surface 218 which is configured to be generally parallel and/or planar with ends of rollers 20 and positioned at wear zone 280. The cheek plate apparatus 200 may further comprise a top portion 220 having a first hoist 222 and/or a second hoist 224 for lifting, moving, installing, uninstalling, and transporting the cheek plate apparatus 200. The cheek plate apparatus 200 may further comprise indexing means 226 which is held in place with respect to the top portion 220 by holding means 225. Indexing means 226 may be moved away from the wear bar 210 to let the wear bar slide downwardly—thereby allowing the wear surface 218 to move closer towards the ends of rollers 20. Conversely, indexing means 226 may be moved closer to the wear bar 210 to prevent the wear bar 210 from sliding downwardly. Wear bar 210 may be raised and lowered, or completely removed from the cheek plate apparatus 200 by disengaging indexing means 226. Holding means 225 may be provided to maintain the indexing means 226, and, consequently, the wear bar 210, in a proper orientation/position. Holding means 225 may comprise a screw, bolt, pin, or other fastener in combination with an aperture through the panel of indexing means 226, and an aperture through top portion 220. When the indexing means 226 is set to effectively position the wear surface 218 of the wear bar 210 in the appropriate location within a wear zone 280, the holding means 125 may be engaged.

As similarly described for FIG. 1, the cheek plate apparatus 200 may further comprise a first side, an angled back side, a second side, and an angled front side which receives, holds, and/or maintains the wear bar in position relative to the cheek plate apparatus 200. For example, one or more sides may serve to keep wear bar 210 oriented at an angle with respect to the cheek plate apparatus 200 (e.g., at an angle with respect to top portion 220). The cheek plate apparatus 200 may further comprise a front plate 230, a back plate 234, an angled lead-in plate 235, a transverse plate 236, and one or more flanges 239 configured to support and/or hold a first roller wear plate 240 via a first connection 241 and/or a second roller wear plate 242 via a second connection 243. Connecting means such as a number of bolts, through holes in the one or more flanges 239, and threaded apertures within wear plates 240, 242 may be provided to secure the wear plates 240, 242 to the cheek plate apparatus 200.

A first wear plate 250 may be provided on an inner surface of the cheek plate assembly to serve as a wear surface component. The first wear plate 250 may comprise a thick substrate of a hard material (e.g., tungsten carbide). In use, feed rock bounces off the first wear plate 250 and effectively prevents premature wear of portions of the cheat plate apparatus 200. The cheek plate apparatus 200 may further comprise a first and/or a second 272 shroud to prevent dust and ground material from working its way into the bearings of a roller press 1 and/or other components of a roller press 1. Wear bar 210 protects wear zone 280 with longevity, where extreme erosion is prevalent.

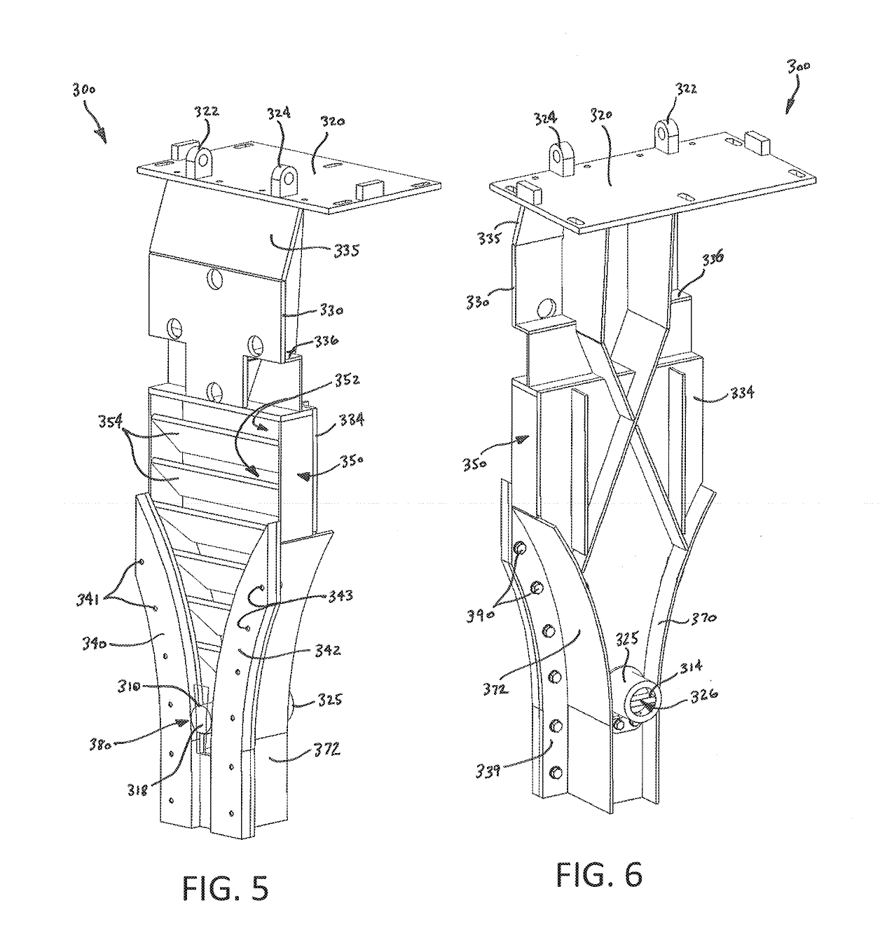

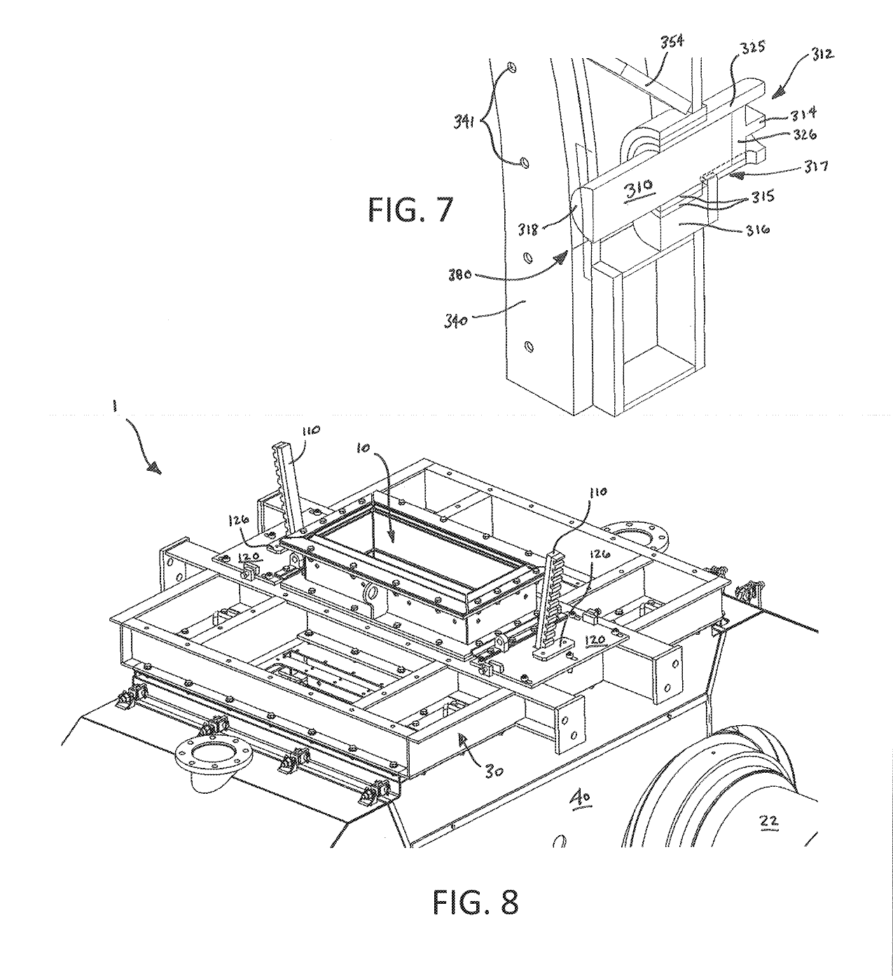

FIGS. 5-6 show another embodiment of a cheek plate assembly and arrangement of surface wear components according to some embodiments. A cheek plate apparatus 300 may comprise an elongated wear bar 310 provided within a wear assembly 312. The wear bar 310 may be configured in different lengths, materials, cross-sectional sizes, and cross-sectional shapes. In preferred embodiments, a distal horizontal end of the wear bar 310 comprises a wear surface 318 which is configured to be generally parallel and/or planar with ends of rollers 20. The cheek plate apparatus 300 may further comprise a top portion 320 having a first hoist 322 and/or a second hoist 324 for lifting, moving, installing, uninstalling, and transporting the cheek plate apparatus 300. The cheek plate apparatus 300 may further comprise indexing means 326 which is held in place by holding means 325. In the particular embodiment shown, both the wear bar 310 and indexing means 326 are held in place by holding means 325, and holding means 325 may comprise a tubular structure or aperture within the cheek plate apparatus 300. Holding means 325 may comprise one or more bushings or bearings 315 such as a greased or low-friction sleeve to prevent wear bar 310 from binding or seizing over time. The one or more bushings or bearings 315 may be provided within a mounting block 316 which forms a frame portion of the cheek plate apparatus 300. Mounting block 316 may comprise a portion of a boss which is machined or formed on the cheek plate apparatus 300 by casting or welding. An anti-rotation mechanism 317 may be provided to the wear assembly 312 in order to prevent spinning or rotation of the wear bar 310 within holding means 325 during use. The anti-rotation mechanism 317 may comprise, without limitation, a protrusion extending from the mounting block 316 or other portion of the cheek plate apparatus 300 into an elongated slot or flat provided within or on the wear bar 310 as shown.

Indexing means 326 may comprise a screw that may be turned and/or tightened against wear bar 310 to force the wear surface 318 of the wear bar 310 towards a nip portion of rollers 20, adjacent a wear zone 380. However, while not shown, the indexing means 326 could comprise a spur or a worm gear, a hydraulic ram, a mechanical linkage, or another mechanism for moving wear bar 310 within the holding means 325 of the cheek plate apparatus 300, without limitation. In some instances, for example, the wear bar 310, may, itself, be threaded and provided with a torque-transfer feature like a slit or hexagonal aperture or head, wherein the indexing means 326 comprises complimentary threads on the holding means 325. In other instances, for example, rather than a smooth outer surface, the wear bar 310 may comprise teeth and roots as in FIGS. 1-4, wherein a spur gear or worm gear would be provided to drive the wear bar horizontally towards rollers 20 and set/hold the position of the wear bar. As it is shown in the drawings, the indexing means 326 may be positioned away from the wear bar 310 and removed from holding means 325 in order to remove the wear bar 310—thereby allowing replacement of the wear bar 310. Indexing means 326 may also be positioned towards the wear bar 310 in order to move the wear surface 318 closer towards the ends of rollers 20 adjacent to wear zone 380. Holding means 325 may also serve to maintain the indexing means 326 in a proper orientation/position. Holding means 325 may, for example, further comprise a set screw, cross-bolt, pin, or other fastener for use in combination with a complimentary transverse aperture through the wear bar 310 and/or indexing means 326; or for use in combination against a flat portion provided on an outer surface of the wear bar 310 and/or indexing means 326. In such instances, holding means 325 may also comprise a transverse aperture. Alternatively, in such instances, a wedge or other feature may be provided coaxially with the wear bar 326 and/or indexing means 326. When the indexing means 326 is set to effectively position the wear surface 318 of the wear bar 310 in the appropriate location within a wear zone 380, the holding means 325 may be engaged. Means 314 for adjusting indexing means 326 may comprise a tab (as shown) or other equivalent torque-transfer feature in order to facilitate the positioning and re-positioning of the wear bar 310.

The cheek plate apparatus 300 may further comprise a front plate 330, a back plate 334, an angled lead-in plate 335, a transverse plate 336, and one or more flanges 339 configured to support and/or hold a first roller wear plate 340 via a first connection 341 and/or a second roller wear plate 342 via a second connection 343. Connecting means 390 such as a number of bolts, through holes in the one or more flanges 339, and threaded apertures within wear plates 340, 342 may be provided to secure the wear plates 340, 342 to the cheek plate apparatus 300.

A rock box 350 may be provided on an inner surface of the cheek plate assembly to serve as a wear surface component. The rock box 350 may comprise a compartment comprised of a series of one or more angular pockets 352. Angular pockets 352 may be formed by placing one or more removable slats 354 within the rock box 350. Angled slots (not clearly shown) may be provided within inner portions of the rock box 350 to accommodate the removable slats 354 and allow the removable slats 354 to remain fixed within rock box 350. In use, feed rock collects within the angular pockets 352 and effectively forms an autogenous layer on the cheek plate apparatus 300. As feed rock enters a roller, it will generally hit material disposed within angular pockets 352, and will therefore, not likely rub or wear down portions of the cheek plate assembly 300. The cheek plate apparatus 300 may further comprise a first 370 and/or a second 372 shroud to prevent dust and ground material from working its way into the bearings of a roller press 1 and/or other components of a roller press 1.

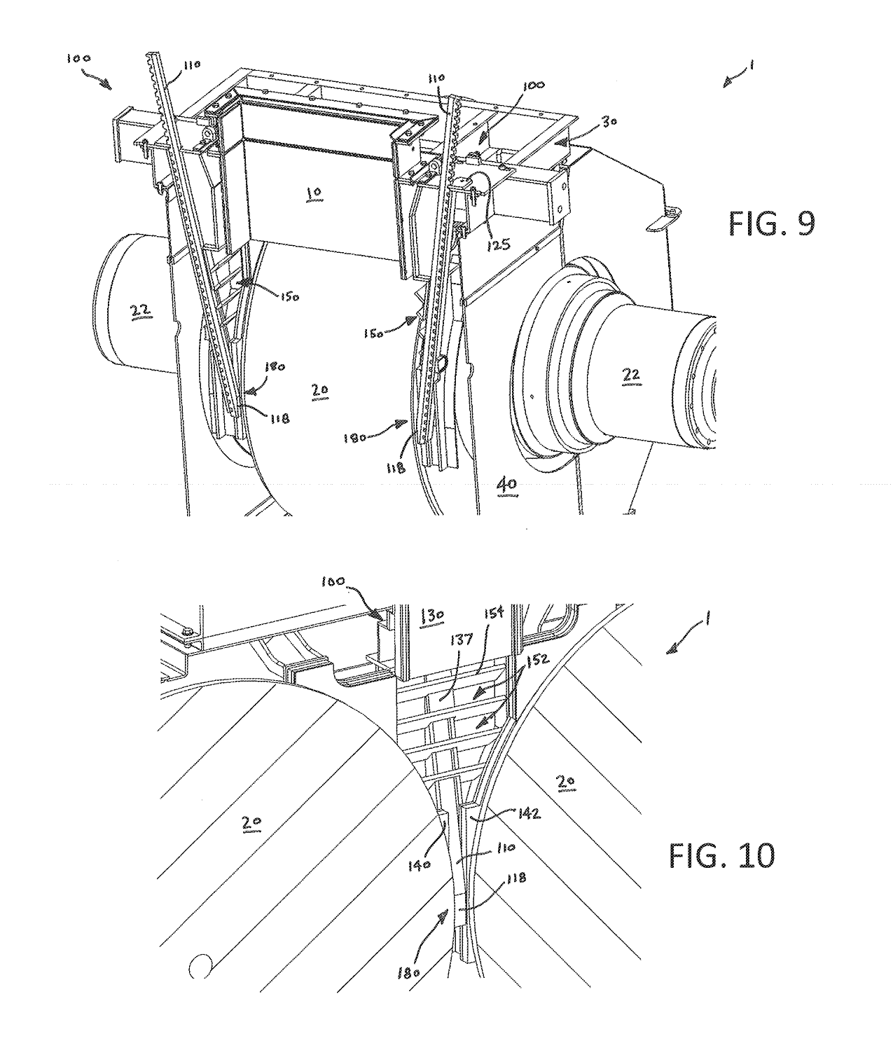

FIG. 8-10 show cheek plate assemblies 100 installed and in use within a roller press 1 according to some embodiments. The roller press 1 comprises two rollers 20—each being provided concentrically on an axle shaft 22. A pair of cheek plate assemblies 100 according to the invention is positioned (using first 122 and second 124 hoists) against or within an upper frame 30 or housing 40 of the roller press 1. A feedbox 10 provides a means of ingress of material for crushing/grinding. Housing 40 prevents dust and material from escaping or causing significant dust in locations which are adjacent the roller press 1. Turning to FIG. 10, a cutaway view of a grinding roller 1 is provided. The cutaway view is located adjacent ends of rollers 20 adjacent a nip—looking outward. Since, in the wear zone 180, high flow rates of both feed material and autogenous layer can spill out of the nip and bore a generally diamond-shaped hole through conventional cheek plate assemblies, wear bar 110 having indexing means 126 is provided at the wear zone. A flat end portion of the wear bar 110 forms a wear surface 118 which suffers the brunt of the wear within wear zone 180. The wear surface 118 may be generally angled with respect to top portion 120 as shown, or it might be perpendicular (not shown) or parallel (FIGS. 5, 6, 11, 12) to the nip of a roller press 1. Each cheek plate assembly 100 may be removed or repaired independently of the other.

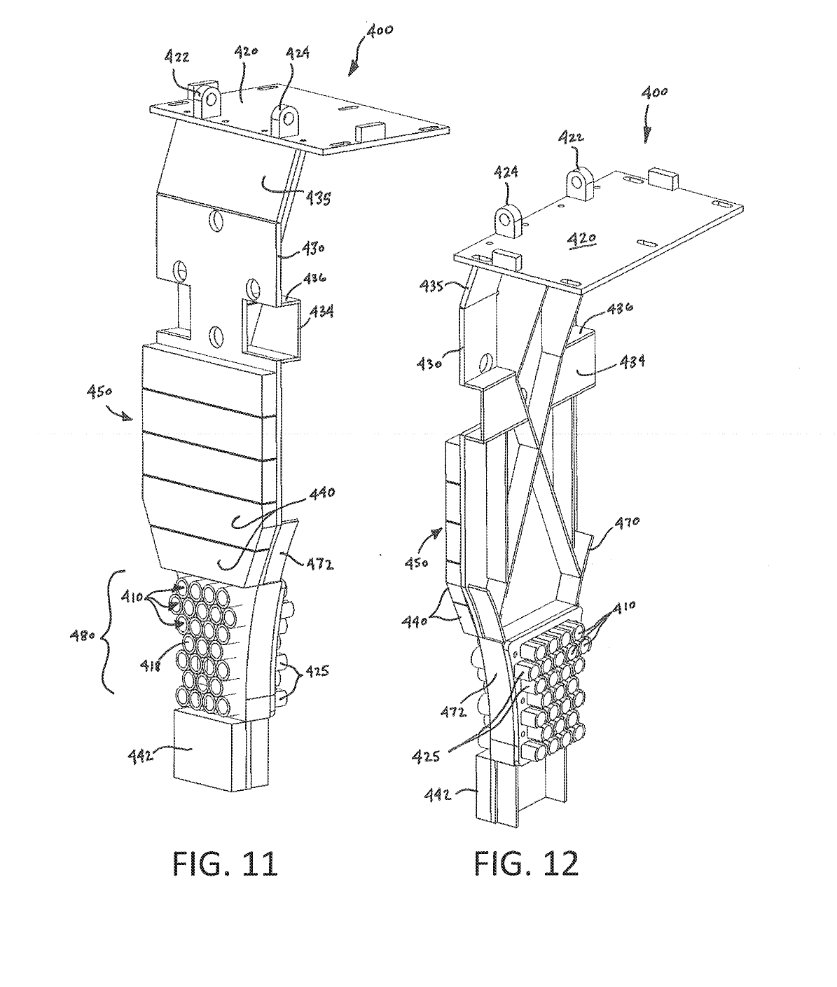

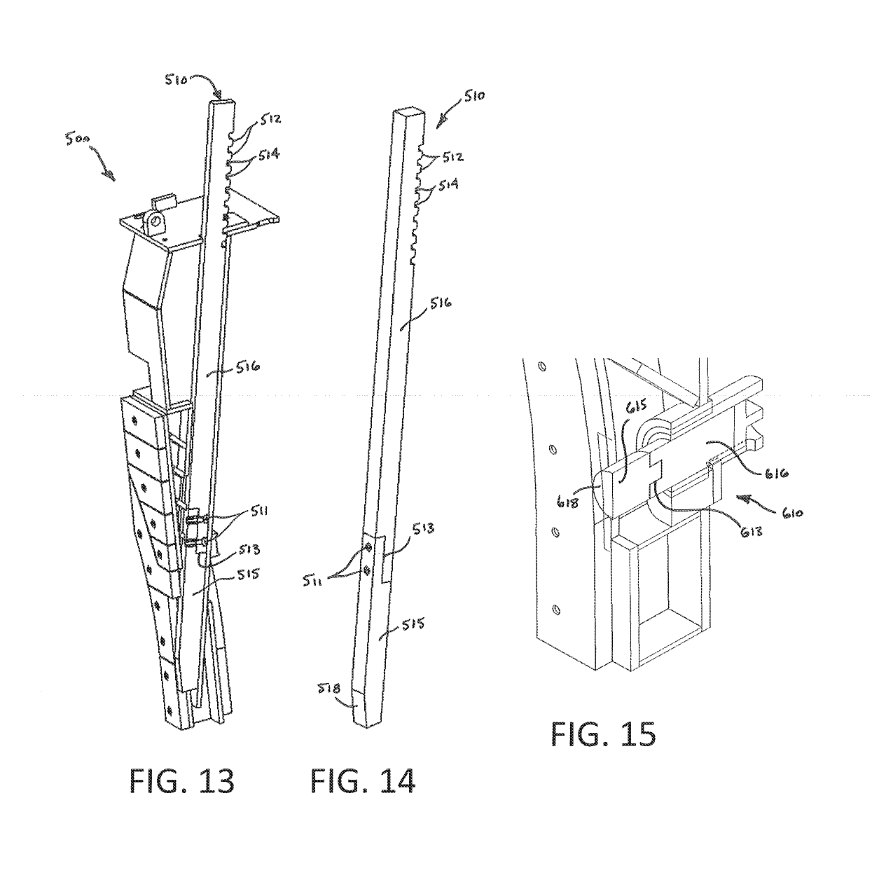

FIGS. 11 and 12 show yet another embodiment of a cheek plate apparatus 400 and a possible arrangement of surface wear components according to some embodiments. The cheek plate apparatus 400 may comprise a plurality of wear bars 410. The wear bars 410 may be configured to have different lengths, materials, cross-sectional sizes, and cross-sectional shapes, or they may be uniform and homogeneous in length, material, cross-sectional size, and/or cross-sectional shape as shown. In preferred embodiments, wear bars 410 may be comprised of wear studs which are typically used on wear surfaces of a roller 20. In this regard, backup wear bars 410 are plentiful. In other embodiments, wear bars 410 are long rods (not shown) which extend well past the cheek plate apparatus 400 and are held in place with holding means 425, which may comprise a tubular structure or aperture within the cheek plate apparatus 400. Each distal end of each wear bar 410 comprises a wear surface 418 which is configured to be generally parallel and/or planar with ends of rollers 20 during installation and use. The cheek plate apparatus 400 may further comprise a top portion 420 having a first hoist 422 and/or a second hoist 424 for lifting, moving, installing, uninstalling, and transporting the cheek plate apparatus 400. The cheek plate apparatus 400 may further comprise indexing means (not shown) which may be used to move wear bars 410 in and out towards and away from rollers 20. For example, while not shown, indexing means may comprise an external screw or thread portion provided to the plurality of wear bars 410, and complimentary female screw or thread portions being provided to holding means 425. In such instances, the wear bars 410 may be turned within the holding means 425 to force the wear surface 418 of wear bars 410 towards a nip portion of rollers 20, adjacent a wear zone 480. In the particular embodiment shown, wear bars 410 may be held in place by holding means 425 using friction, glue, or adhesive in a similar manner which is done for roller 20 surfaces. Holding means 425 may comprise a portion of a boss which is machined or formed by casting or welding.

In some embodiments (while not shown), wear bars 410 may be loosely captured in holding means 425, and a plate (not shown) may be placed over the back ends of wear bars 410 in the wear zone 480. The plate may then be adjustably attached to a portion of the cheek plate apparatus 400 (e.g., via anchor bolt and nut). The plate may be tightened to the cheek plate apparatus 400 (e.g., by tightening nuts) to provide a clamping/retaining force to each of the plurality of wear bars 410.

In some embodiments, holding means 425 may, for example, comprise a set screw, cross-bolt, pin, or other fastener for use in combination with a complimentary transverse aperture through the wear bars 410. Alternatively, holding means 425 may comprise flat portions provided on outer surfaces of the wear bars 410 which mate with portions of said set screw, cross-bolt, pin, or other fastener. In such instances, holding means 425 may also comprise a transverse aperture. Alternatively, a wedge or other locking feature may be provided coaxially with the wear bars 410 to engage flat portions provided on outer surfaces of the wear bars 410.

The cheek plate apparatus 400 may further comprise a front plate 430, a back plate 434, an angled lead-in plate 435, and a transverse plate 436. An armored section 450 may be provided to central portions of the cheek plate apparatus 400. The armored section 450 may comprise one or more central wear plates 440 which may be configured for easy removal and replacement. Below the wear zone 480, one or more lower wear plates 442 may be provided. The cheek plate apparatus 400 may further comprise a first 470 and/or a second 472 shroud to prevent dust and ground material from working its way into the bearings of a roller press 1 and/or other components of a roller press 1.

A contractor or other entity may provide a grinding roller or operate a grinding roller apparatus in whole, or in part, as shown and described. For instance, the contractor may receive a bid request for a project related to designing or operating a grinding roller apparatus, or the contractor may offer to design any number of cheek plate apparatus or components thereof, or a process for a client involving one or more of the features shown and described herein. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer. The contractor may subcontract the fabrication, delivery, sale, or installation of a component of the devices disclosed, or of other devices used to provide said devices. The contractor may also survey a site and design or designate one or more storage areas for storing the material used to manufacture the devices, or for storing the devices and/or components thereof. The contractor may also maintain, modify, or upgrade the provided devices. The contractor may provide such maintenance or modifications by subcontracting such services or by directly providing those services or components needed for said maintenance or modifications, and in some cases, the contractor may modify a preexisting grinding roller apparatus, roller press, cheek plate, or parts thereof with a “retrofit kit” to arrive at a modified apparatus comprising one or more method steps, devices, components, or features of the systems and processes discussed herein.

Although the invention has been described in terms of particular embodiments and applications, one of ordinary skill in the art, in light of this teaching, can generate additional embodiments and modifications without departing from the spirit of or exceeding the scope of the claimed. For example, in some embodiments, while not shown, multiple wear assemblies may be placed at numerous wear zones on a single cheek plate apparatus. In other words, a cheek plate having a plurality of localized wear zones 180, 280, 380, 480 thereon (in which all wear zones experience some level of extreme localized wear) may be provided with multiple wear bars 110, 210, 310, 410 which are provided in different locations throughout the cheek plate. Different types of wear bars may be provided on a single cheek plate apparatus, and may be purposed for various types, amounts, and patterns of wear.

Accordingly, it is to be understood that the drawings and descriptions herein are proffered by way of example to facilitate comprehension of the invention and should not be construed to limit the scope thereof.

### REFERENCE NUMERAL IDENTIFIERS

1 Roller press

10 Feed box

20 Roller

22 Axle shaft

30 Frame

40 Housing

100, 200, 300, 400 Cheek plate apparatus

110, 210, 310, 410 Wear bar

112, 212 Teeth

114, 214 Root

118, 218, 318, 418 Wear surface

120, 220, 320, 420 Top portion

122, 222, 322, 422 First hoist

124, 224, 324, 424 Second hoist

125, 225, 325, 425 Holding means

126, 226, 326 Indexing means

130, 230, 330, 430 Front plate

131 First side

132 Angled back side

133 Second side

134, 234, 334, 434 Back plate

135, 235, 335, 435 Angled lead-in plate

136, 236, 336, 436 Transverse plate

137 Angled front side

139, 239, 339 Flange

140, 240, 340 First roller wear plate

141, 241, 341 First connection

142, 242, 342 Second roller wear plate

143, 243, 343 Second connection

150, 350 Rock box

152, 352 Pockets

154, 354 Removable slats

170, 370, 470 First shroud

172, 272, 372, 472 Second shroud

180, 280, 380, 480 Wear zone

190, 390 Connecting means

250 First wear plate

312 Wear assembly

314 Means for adjusting indexing means

315 Bearing

316 Mounting block

317 Anti-rotation mechanism

440 Central wear plate

442 Lower wear plate

450 Armored section

1. A roller press comprising:
a pair of side-by-side rollers configured to form a nip therebetween and configured to grind or crush feed material; each of the side-by-side rollers sharing a first end and a second end; and,
a pair of cheek plate assemblies, wherein one of the pair of cheek plate assemblies is provided adjacent said first end of the rollers and the other of the pair of cheek plate assemblies is provided adjacent said second end of the rollers;
wherein each cheek plate assembly is configured for engagement with a frame and/or a housing portion of the roller press; each cheek plate assembly further comprising at least one wear bar, and indexing means which is configured to provide a finite or infinite number of adjustments to said at least one wear bar; wherein said at least one wear bar is adjustable so as to accommodate wear of said at least one wear bar over time;
wherein the at least one wear bar is configured with a wear surface which is located proximate to a wear zone; and,
wherein the at least one wear bar is configured to greatly increase wear life in said wear zone.

2. The roller press according to claim 1, wherein the roller press further comprises a surface wear component selected from at least one of the following: a wear surface, a front plate, an angled lead-in plate, a first roller wear plate, a second roller wear plate, a rock box, a first shroud, a second shroud, a first wear plate, a central wear plate, a lower wear plate, or an armored section.

3. The roller press according to claim 1, wherein each cheek plate assembly comprises more than one wear bar at the wear zone.

4. (canceled)

5. (canceled)

6. The roller press according to claim 1, wherein said indexing means further comprises holding means for holding said indexing means in place, thereby preventing movement of the at least one wear bar.

7. (canceled)

8. The roller press according to claim 1, wherein said indexing means further comprises holding means for holding said indexing means in place, thereby preventing movement of the at least one wear bar.

9. The roller press according to claim 1, wherein said at least one wear bar comprises a hard material such as a ceramic or carbide-based material or alloy.

10. A cheek plate assembly configured for engagement with a frame and/or a housing portion of a roller press; the cheek plate assembly further comprising at least one wear bar, and indexing means which is configured to provide a finite or infinite number of adjustments to said at least one wear bar; wherein said at least one wear bar is adjustable to accommodate wear of said at least one wear bar over time;
wherein the at least one wear bar is configured with a wear surface which is located proximate to a wear zone; and,
wherein the at least one wear bar is of sufficient dimensions to greatly increase wear life in said wear zone.

11. The cheek plate assembly according to claim 10, further comprising a surface wear component selected from at least one of the following: a wear surface, a front plate, an angled lead-in plate, a first roller wear plate, a second roller wear plate, a rock box, a first shroud, a second shroud, a first wear plate, a central wear plate, a lower wear plate, or an armored section.

12. The cheek plate assembly according to claim 10, wherein each cheek plate assembly comprises more than one wear bar at the wear zone.

13. (canceled)

14. (canceled)

15. The cheek plate assembly according to claim 10, wherein said indexing means further comprises holding means for holding said indexing means in place, thereby preventing movement of the at least one wear bar.

16. (canceled)

17. The cheek plate assembly according to claim 10, wherein said indexing means further comprises holding means for holding said indexing means in place, thereby preventing movement of the at least one wear bar.

18. The cheek plate assembly according to claim 10, wherein said at least one wear bar comprises a hard material such as a ceramic or carbide-based material or alloy.

19. A method of crushing/grinding comprising:
providing a roller press having a cheek plate assembly configured for engagement with a frame and/or a housing portion of said roller press; the cheek plate assembly further comprising at least one wear bar; wherein the at least one wear bar is configured with a wear surface which is located proximate to a wear zone; and, wherein the at least one wear bar is of sufficient dimensions to greatly increase wear life in said wear zone;
crushing/grinding feed material until the wear surface of the at least one wear bar is worn;
adjusting, using indexing means a position of the at least one wear bar such that the worn wear surface moves closer to a roller within the roller press; and,
and holding a position of the at least one wear bar relative to said roller within the roller press using holding means.
